(19) United States
(12) Patent Application Publication
(10) Pub. No.: US 2011/0072251 A1
(43) Pub. Date: Mar. 24, 2011

(54) PILE PROCESSING SYSTEM AND METHOD FOR PARALLEL PROCESSORS

(75) Inventors: William C. Lynch, Palo Alto, CA (US); Krasimir D. Kolarov, Menlo Park, CA (US); Steven E. Saunders, Cupertino, CA (US)

(73) Assignee: DROPLET TECHNOLOGY, INC., Palo Alto, CA (US)

(21) Appl. No.: 12/765,789

(22) Filed: Apr. 22, 2010

Related U.S. Application Data
(63) Continuation of application No. 10/447,455, filed on May 28, 2003, now abandoned.
Application No. 10/447,455 is a continuation-in-part of application No. 10/418,363, filed on Apr. 17, 2003.
(60) Provisional application No. 60/385,253, filed on May 28, 2002.
(60) Provisional application No. 60/385,250, filed on May 28, 2002.

(51) Int. Cl. G06F 9/38

(52) U.S. Cl. 712/241; 712/E09.045

(57) ABSTRACT

A system, method and computer program product are provided for processing exceptions. Initially, computational operations are processed in a loop. Moreover, exceptions are identified and stored while processing the computational operations. Such exceptions are then processed separate from the loop.

### RELATED APPLICATIONS

The present application is a continuation of patent application filed on May 28, 2003 under Ser. No. 10/447,455, which is a continuation-in-part of a patent application filed on Apr. 17, 2003 under Ser. No. 10/418,363, and claims priority from a first provisional application filed May 28, 2002 under Ser. No. 60/385,253, and a second provisional application filed May 28, 2002 under Ser. No. 60/385,250; each application is incorporated herein by reference in their entirety.

### FIELD OF THE INVENTION

The present invention relates to data processing, and more particularly to data processing in parallel.

### BACKGROUND OF THE INVENTION

Parallel Processing

Parallel processors are difficult to program for high throughput when the required algorithms have narrow data widths, serial data dependencies, or frequent control statements (e.g., “if”, “for”, “while” statements). There are three types of parallelism that may be used to overcome such problems in processors.

The first type of parallelism is supported by multiple functional units and allows processing to proceed simultaneously in each functional unit. Super-scaler processor architectures and very long instruction word (VLIW) processor architectures allow instructions to be issued to each of several functional units on the same cycle. Generally the latency, or time for completion, varies from one type of functional unit to another. The most simple functions (e.g. bitwise AND) usually complete in a single cycle while a floating add function may take 3 or more cycles.

The second type of parallel processing is supported by pipelining of individual functional units. For example, a floating ADD may take 3 cycles to complete and be implemented in three sequential sub-functions requiring 1 cycle each. By placing pipelining registers between the sub-functions, a second floating ADD may be initiated into the first sub-function on the same cycle that the previous floating ADD is initiated into the second sub-function. By this means, a floating ADD may be initiated and completed every cycle even though any individual floating ADD requires 3 cycles to complete.

The third type of parallel processing available is that of devoting different field-partitions of a word to different instances of the same calculation. For example, a 32 bit word on a 32 bit processor may be divided into 4 field-partitions of 8 bits. If the data items are small enough to fit in 8 bits, it may be possible to process all 4 values with the same single instruction.

It may also be possible in each single cycle to process a number of data items equal to the product of the number of field-partitions times the number of functional unit initiations.

Loop Unrolling

There is a conventional and general approach to programming multiple and/or pipelined functional units: find many instances of the same computation and perform corresponding operations from each instance together. The instances can be generated by the well-known technique of loop unrolling or by some other source of identical computation.

While loop unrolling is a generally applicable technique, a specific example is helpful in learning the benefits. Consider, for example, Program A below.

Program A

for i=0:1:255, {S(i)};

where the body S(i) is some sequence of operations {S1(i); S2(i); S3(i); S4(i); S5(i);}

dependent on i and where the computation S(i) is completely independent of the computation S(j), j≠i. It is not assumed that the operations S1(i); S2(i); S3(i); S4(i); S5(i); are independent of each other. To the contrary, it assumed that dependencies from one operation to the next prohibit reordering.

It is also assumed that these same dependencies require that the next operation not begin until the previous one is complete. If each pipelined operation required two cycles to complete (even though the pipelined execution unit may produce a new result each cycle), the sequence of five operations would require 10 cycles for completion. In addition, the loop branch may typically require an additional 3 cycles per loop unless the programming tools can overlap S4(i); S5(i); with the branch delay. Program A thus requires 640 (256/4*10) cycles to complete if the branch delay is overlapped and 832 (256/4*13) cycles to complete if the branch delay is not overlapped.

Program B below is equivalent to Program A.

Program B

for n=0:4:255, {S(n); S(n+1); S(n+2); S(n+3);};

The loop has been “unrolled” four times. This reduces the number of expensive control flow changes by a factor of 4. More importantly, it provides the opportunity for reordering the constituent operations of each of the four S(i). Thus, Programs A and B are equivalent to Program C.

Program C

for n = 0:4:255, { S1(n); S2(n); S3(n); S4(n); S5(n);
S1(n+1); S2(n+1); S3(n+1); S4(n+1); S5(n+1);
S1(n+2); S2(n+2); S3(n+2); S4(n+2); S5(n+2);
S1(n+3); S2(n+3); S3(n+3); S4(n+3); S5(n+3);
};

With the set of assumptions about dependencies and independencies above, one may create the equivalent Program D.

Program D

for n = 0:4:255, { S1(n); S1(n+1); S1(n+2); S1(n+3);
S2(n); S2(n+1); S2(n+2); S2(n+3);
S3(n); S3(n+1); S3(n+2); S3(n+3);
S4(n); S4(n+1); S4(n+2); S4(n+3);
S5(n); S5(n+1); S5(n+2); S5(n+3);
};

On the first cycle S1(n); S1(n+1); can be issued and S1(n+2); S1(n+3); can be issued on the 2nd cycle. At the beginning of the third cycle S1(n); S1(n+1); is completed (two cycles have gone by) so that S2(n); S2(n+1); can be issued. Thus, the next two operations can be issued on each subsequent cycle so that the whole body can be executed in the same 10 cycles. Program D operates in less than a quarter of time of Program A. Thus, the well-known benefit of loop unrolling is illustrated.

Most parallel processors necessarily have conditional branch instructions which require several cycles of delay between the instruction itself and the point at which the branch actually takes place. During this delay period, other instructions can be executed. The branch may cost as little as one instruction issue opportunity as long as the branch condition is known sufficiently early and the compiler or other programming tools support the execution of instructions during the delay. This technique can be applied to even Program A as the branch condition (i=255) is known at the top of the loop.

Excessive unrolling may, however, be counter productive. First, once all of the issue opportunities are utilized (as in Program D), there is no further acceleration with additional unrolling. Second, each of the unrolled loop turns, in general, requires additional registers to hold the state for that particular turn. The number of registers required is linearly proportional to the number of turns unrolled. If the total number of registers required exceeds the number available, some of the registers may be spilled to a cache and then restored on the next loop turn. The instructions required to be issued to support the spill and reload lengthen the program time. Thus, there is an optimum number of times to unroll such loops.

Unrolling Loops Containing Exception Processing

Consider now Program A′.

Program A′

for i=0:1:255, {S(i); if C(i) then T(I(i))};

where C(i) is some rarely true (say, 1 in 64) exception condition dependent on S(i); only, and T(I(i)) is some lengthy exception processing of, say, 1024 operations. I(i) is the information computed by S(i) that is required for the exception processing. For example, it may be assumed T(I(i)) adds, on the average, 16 operations to each loop turn in Program A, an amount which exceeds the 4 operations in the main body of the loop. Such rare but lengthy exception processing is a common programming problem in that it is not clear how to handle this without losing the benefits of unrolling.

Guarded Instructions

One approach of handling such problem is through the use of guarded instructions, a facility available on many processors. A guarded instruction specifies a Boolean value as an additional operand with the meaning that the instruction always occupies the expected functional unit, but the retention of the result is suppressed if the guard is false.

In implementing an “if-then-else,” the guard is taken to be the “if” condition. The instructions of the “then” clause are guarded by the “if” condition and the instructions of the “else” clause are guarded by the negative of the “if” condition. In any case, both clauses are executed. Only instances with the guard being “true” are updated by the results of the “then” clause. Moreover, only the instances with the guard being “false” are updated by the results of the “else” clause. All instances execute the instructions of both clauses, enduring this penalty rather than the pipeline delay penalty required by a conditional change in the control flow.

The guarded approach suffers a large penalty if, as in Program A′, the guards are preponderantly “true” and the “else” clause is large. In that case, all instances pay the large “else” clause penalty even though only a few are affected by it. If one has an operation S to be guarded by a condition C, it may be programmed as guard(C, S);

First Unrolling

Program A′ may be unrolled to Program D′ as follows:

for n = 0:4:255, { S1(n); S1(n+1); S1(n+2); S1(n+3);
S2(n); S2(n+1); S2(n+2); S2(n+3);
S3(n); S3(n+1); S3(n+2); S3(n+3);
S4(n); S4(n+1); S4(n+2); S4(n+3);
S5(n); S5(n+1); S5(n+2); S5(n+3);
if C(n) then T(I(n));
if C(n+1) then T(I(n+1));
if C(n+2) then T(I(n+2));
if C(n+3) then T(I(n+3));
};

Given the above example parameters, no T(I(n)) may be executed in 77% of the loop turns, one T(I(n)) may be executed in 21% of the loop turns, and more than one T(I(n)) in only 2% of the loop turns. Clearly, there is little to be gained by interleaving the operations of T(I(n)), T(I(n+1)), T(I(n+2)) and T(I(n+3)).

There is thus a need for improved techniques for processing exceptions.

### DISCLOSURE OF THE INVENTION

A system, method and computer program product are provided for processing exceptions. Initially, computational operations are processed in a loop. Moreover, exceptions are identified and stored while processing the computational operations. Such exceptions are then processed separate from the loop.

In one embodiment, the computational operations may involve non-significant values. For example, the computational operations may include counting a plurality of zeros. Still yet, the computational operations may include either clipping and/or saturating operations.

In another embodiment, the exceptions may include significant values. For example, the exceptions may include non-zero data.

As an option, the computational operations may be processed at least in part utilizing a transform module, quantize module and/or entropy code module of a data compression system, for example. Thus, the processing may be carried out to compress data. Optionally, the data may be compressed utilizing wavelet transforms, discrete cosine transforms, and/or any other type of de-correlating transform.

### BRIEF DESCRIPTION OF THE DRAWINGS

FIG. 1 illustrates a framework for compressing/decompressing data, in accordance with one embodiment.

FIG. 2 illustrates a method for processing exceptions, in accordance with one embodiment.

FIG. 3 illustrates an exemplary operational sequence of the method of FIG. 2.

FIGS. 4-9 illustrate various graphs and tables associated various operational features, in accordance with different embodiments.

### DESCRIPTION OF THE PREFERRED EMBODIMENTS

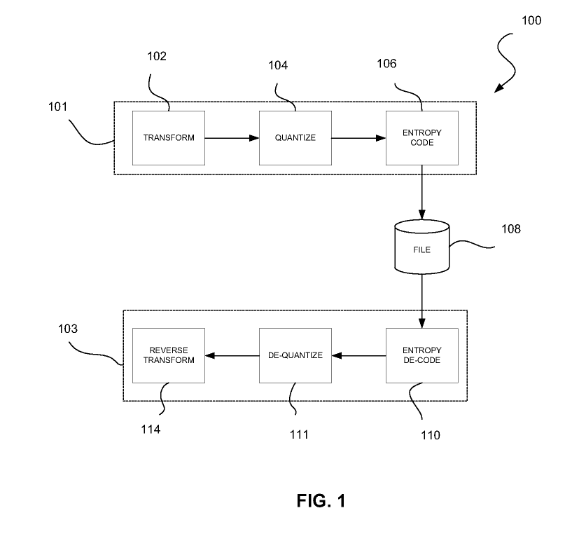

FIG. 1 illustrates a framework 100 for compressing/decompressing data, in accordance with one embodiment. Included in this framework 100 are a coder portion 101 and a decoder portion 103, which together form a “codec.” The coder portion 101 includes a transform module 102, a quantizer 104, and an entropy encoder 106 for compressing data for storage in a file 108. To carry out decompression of such file 108, the decoder portion 103 includes a reverse transform module 114, a de-quantizer 111, and an entropy decoder 110 for decompressing data for use (i.e. viewing in the case of video data, etc).

In use, the transform module 102 carries out a reversible transform, often linear, of a plurality of pixels (i.e. in the case of video data) for the purpose of de-correlation. Next, the quantizer 104 effects the quantization of the transform values, after which the entropy encoder 106 is responsible for entropy coding of the quantized transform coefficients. The various components of the decoder portion 103 essentially reverse such process.

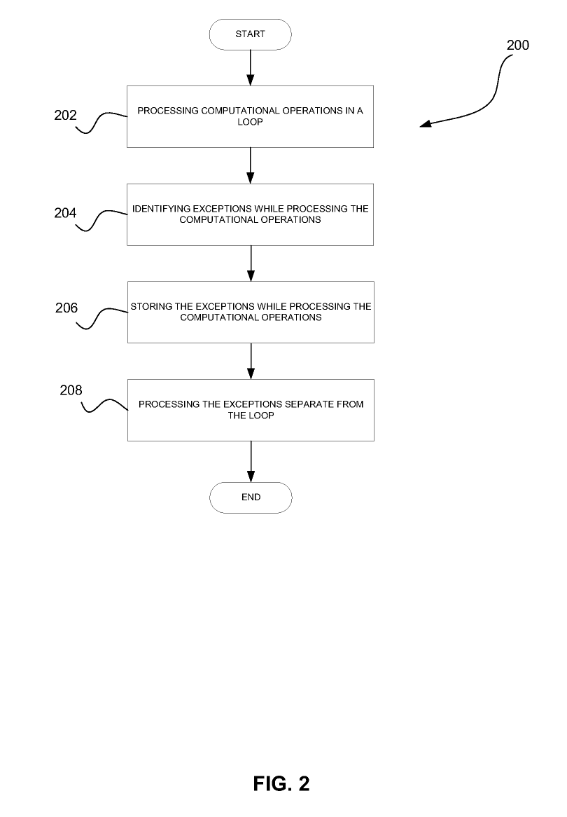

FIG. 2 illustrates a method 200 for processing exceptions, in accordance with one embodiment. In one embodiment, the present method 200 may be carried out in the context of the framework 100 of FIG. 1. It should be noted, however, that the method 200 may be implemented in any desired context.

Initially, in operation 202, computational operations are processed in a loop. In the context of the present description, the computational operations may involve non-significant values. For example, the computational operations may include counting a plurality of zeros, which is often carried out during the course of data compression. Still yet, the computational operations may include either clipping and/or saturating in the context of data compression. In any case, the computational operations may include the processing of any values that are less significant than other values.

While the computational operations are being processed in the loop, exceptions are identified and stored in operations 204-206. Optionally, the storing may include storing any related data required to process the exceptions. In the context of the present description, the exceptions may include significant values. For example, the exceptions may include non-zero data. In any case, the exceptions may include the processing of any values that are more significant than other values.

Thus, the exceptions are processed separate from the loop. See operation 208. To this end, the processing of the exceptions does not interrupt the “pile” processing of the loop by enabling the unrolling of loops and the consequent improved performance in the presence of branches. The present embodiment particularly enables the parallel execution of lengthy exception clauses. This may be accomplished by writing and rereading a modest amount of data to/from memory. More information regarding various options associated with such technique, and “pile” processing will be set forth hereinafter in greater detail.

As an option, the various operations 202-208 may be processed at least in part utilizing a transform module, quantize module and/or entropy code module of a data compression system. See, for example, the various modules of the framework 100 of FIG. 1. Thus, the operations 202-208 may be carried out to compress/decompress data. Optionally, the data may be compressed utilizing wavelet transforms, discrete cosine transform (DCT) transforms, and/or any other desired de-correlating transforms.

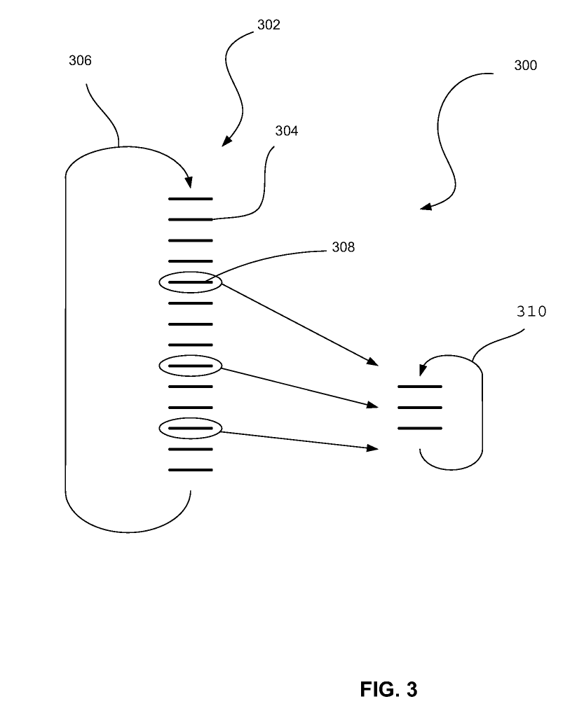

FIG. 3 illustrates an exemplary operation 300 of the method 200 of FIG. 2. While the present illustration is described in the context of the method 200 of FIG. 2, it should be noted that the exemplary operation 300 may be implemented in any desired context.

As shown, a first stack 302 of operational computations 304 are provided for processing in a loop 306. While progressing through such first stack 302 of operational computations 304, various exceptions 308 may be identified. Upon being identified, such exceptions 308 are stored in a separate stack and may be processed separately. For example, the exceptions 308 may be processed in the context of a separate loop 310.

### Optional Embodiments

More information regarding various optional features of such “pile” processing that may be implemented in the context of the operations of FIG. 2 will now be set forth. In the context of the present description, a “pile” is a sequential memory object that may be stored in memory (i.e. RAM). Piles may be intended to be written sequentially and to be subsequently read sequentially from the beginning. A number of methods are defined on pile objects.

For piles and their methods to be implemented in parallel processing environments, their implementations may be a few instructions of inline (i.e. no return branch to a subroutine) code. It is also possible that this inline code contain no branch instructions. Such method implementations will be described below. It is the possibility of such implementations that make piles particularly beneficial.

Table 1 illustrates the various operations that may be performed to carry out pile processing, in accordance with one embodiment.

TABLE 1

| | |
|---|---|
| 1) | A pile is created by the Create_Pile(P) method. |
| | This allocates storage and initializes the internal state |
| | variables. |
| 2) | The primary method for writing to a pile is |
| | Conditional_Append(pile, condition, record). This method |
| | appends the record to the pile pile if and only if the |
| | condition is true. |
| 3) | When a pile has been completely written, it is |
| | prepared for reading by the Rewind_Pile(P) method. This |
| | adjusts the internal variables so that reading may begin |
| | with the first record written. |
| 4) | The method EOF(P) produces a Boolean value |
| | indicating whether or not all of the records of the pile have |
| | been read. |
| 5) | The method Pile_Read(P, record) reads the next |
| | sequential record from the pile P. |
| 6) | The method Destroy_Pile(P) destroys the pile P by |
| | deallocating all of its state variables. |

Using Piles to Split Off Conditional Processing

One may thus transform Program D′ (see Background section) into Program E′ below by means of a pile P.

Program E′

Create_Pile (P);
for n = 0:4:255, { S1(n); S1(n+1); S1(n+2); S1(n+3);
S2(n); S2(n+1); S2(n+2); S2(n+3);
S3(n); S3(n+1); S3(n+2); S3(n+3);
S4(n); S4(n+1); S4(n+2); S4(n+3);
S5(n); S5(n+1); S5(n+2); S5(n+3);
Conditional_Append(P, C(n), I(n));
Conditional_Append(P, C(n+1), I(n+1));
Conditional_Append(P, C(n+2), I(n+2));
Conditional_Append(P, C(n+3), I(n+3));
};
Rewind(P);
while not EOF(P) {
Pile_Read(P, I);
T(I);
};
Destroy_Pile (P);

Program E′ operates by saving the required information I for the exception computation T on the pile P. I records corresponding to the exception condition C(n) are written so that the number (e.g., 16) of I records in P is less than the number of loop turns (e.g., 256) in the original Program A (see Background section).

Afterwards, a separate “while” loop reads through the pile P performing all of the exception computations T. Since P contains records I only for the cases where C(n) was true, only those cases are processed.

The second loop may be more difficult than the first loop because the number of turns of the second loop, while 16 on the average in this example, is indeterminate. Therefore, a “while” loop rather than a “for” loop may be used, terminating when the end of file (EOF) method indicates that all records have been read from the pile.

As asserted above and described below, the Conditional_Append method invocations can be implemented inline and without branches. This means that the first loop is still unrolled in an effective manner, with few unproductive issue opportunities.

Unrolling the Second Loop

The second loop in Program E′ above is not unrolled, but yet is still inefficient. However, one can transform Program E′ into Program F′ below by means of four piles P1, P2, P3, P4. The result is that Program F′ has both loops unrolled with the attendant efficiency improvements.

Program F′

Create_Pile (P1); Create_Pile (P2); Create_Pile (P3); Create_Pile (P4);
for n = 0:4:255, { S1(n); S1(n+1); S1(n+2); S1(n+3);
S2(n); S2(n+1); S2(n+2); S2(n+3);
S3(n); S3(n+1); S3(n+2); S3(n+3);
S4(n); S4(n+1); S4(n+2); S4(n+3);
S5(n); S5(n+1); S5(n+2); S5(n+3);
Conditional_Append(P1, C(n), I(n));
Conditional_Append(P2, C(n+1), I(n+1));
Conditional_Append(P3, C(n+2), I(n+2));
Conditional_Append(P4, C(n+3), I(n+3));
};
Rewind(P1); Rewind (P2); Rewind (P3); Rewind (P4);
while not all EOF(Pi) {
Pile_Read(P1, I1);Pile_Read(P2, I2);
Pile_Read(P3, I3);Pile_Read(P4, I4);
guard(not EOF(P1), S);T(I1);
guard(not EOF(P2), S);T(I2);
guard(not EOF(P3), S);T(I3);
guard(not EOF(P4), S);T(I4);
};
Destroy_Pile (P1); Destroy _Pile (P2); Destroy _Pile (P3);
Destroy _Pile
(P4);

Program F′ is Program E′ with the second loop unrolled. The unrolling is accomplished by dividing the single pile of Program E′ into four piles, each of which can be processed independently of the other. Each turn of the second loop in Program F′ processes one record from each of these four piles. Since each record is processed independently, the operations of each T can be interleaved with the operations of the 3 other T's.

The control of the “while” loop may be modified to loop until all of the piles have been processed. Moreover, the T's in the “while” loop body may be guarded since, in general, all of the piles will not necessarily be completed on the same loop turn. There may be some inefficiency whenever the number of records in two piles differ greatly from each other, but the probabilities (i.e. law of large numbers) are that the piles may contain similar numbers of records.

Of course, this piling technique may be applied recursively. If T itself contains a lengthy conditional clause T′, one can split T′ out of the second loop with some additional piles and unroll the third loop. Many practical applications have several such nested exception clauses.

Implement Pile Processing

The implementations of the pile object and its methods may be kept simple in order to meet the implementation criteria stated above. For example, the method implementations, except for Create_Pile and Destroy_Pile, may be but a few instructions of inline code. Moreover, the implementation may contain no branch instructions.

At its heart, a pile may include an allocated linear array in memory (i.e. RAM) and a pointer, index, whose current value is the location of the next record to read or write. The written size of the array, sz, is a pointer whose value is the maximum value of index during the writing of the pile. The EOF method can be implemented as the inline conditional (sz≦index). The pointer base has a value which points to the first location to write in the pile. It may be set by the Create_Pile method.

The Conditional_Append method copies the record to the pile array beginning at the value of index. Then index is incremented by a computed quantity that is either 0 or the size of the record (sz_record). Since the parameter condition has a value of 1 for true and 0 for false, the index can be computed without a branch as: index=index+condition*sz_record.

Of course, many variations of this computation exist, many of which do not involve multiplying given special values of the variables. It may also be computed using a guard as: guard(condition, index=index+sz_record).

It should be noted that the record may be copied to the pile without regard to condition. If the condition is false, this record may be overwritten by the very next record. If the condition is true, the very next record may be written following the current record. This next record may or may not be itself overwritten by the record thereafter. As a result, it is generally optimal to write as little as possible to the pile even if that means re-computing some (i.e. redundant) data when the record is read and processed.

The Rewind method is implemented simply by sz=index; index=base. This operation records the amount of data written for the EOF method and then resets index to the beginning

The Pile_Read method copies the next portion of the pile (of length sz_record) to I and increments the index as follows: index=index+sz_record. Destroy_Pile deallocates the storage for the pile. All of these techniques (except Create_Pile and Destroy_Pile) may be implemented in a few inline instructions and without branches.

Programming with Field-Partitions

In the case of the large but rare “else” clause, an alternative to guarded processing is pile processing. As each instance begins, the “else” clause transfers the input data to a pile in addressable memory (i.e. cache or RAM). In one context, the pile acts like a file being appended with the input data. This is accomplished by writing to memory at the address given by a pointer. In file processing, the pointer may then be incremented by the size of the data written so that the next write would be appended to the one just completed. In pile processing, the incrementing of the pointer may be made conditional on the guard. If the guard is true, the next write may be appended to the one just completed. If the guard is false, the pointer is not incremented and the next write overlays the one just completed. In the case where the guard is rarely true, the pile may be short and the subsequent processing of the pile with the “else” operations may take a time proportional to just the number of true guards (i.e. false if conditions) rather than to the total number of instances. The trade-off is the savings in “else” operations vs. the extra overhead of writing and reading the pile.

Many processors have special instructions which enable various arithmetic and logical operations to be performed independently and in parallel on disjoint field-partitions of a word. The current description involves methods for processing “bit-at-a-time” in each field-partition. As a running example, consider an example including a 32-bit word with four 8-bit field-partitions. The 8 bits of a field-partition are chosen to be contiguous within the word so the “adds” can be performed and “carry's” propagate within a single field-partition. The commonly available arithmetic field-partition instructions inhibit the carry-up from the most significant bit (MSB) of one field-partition into the least significant bit (LSB) of the next most significant field-partition.

For example, it may be assumed all equal lengths B, a divisor of the word length. Moreover, a field-partition may be devoted to independent instances of an algorithm. Following are some techniques and code sequences that process all of the fields of a word simultaneously with each instruction. These techniques and code sequences use the techniques of Table 2 to avoid changes of control.

TABLE 2

| | |
|---|---|
| A) | replacement of changes of control with |
| | logical/arithmetic calculations. For example, |
| | if (a<0) then c=b else c=d |
| | can be replaced by |
| | c = (a<0 ? b : d) |
| | which can in turn be replaced by |
| | c = b*(a<0) + d*(1−(a<0)) |
| B) | use logical values to conditionally suppress the |
| | replacement of variable values |
| | if (a<0) then c=b |
| | becomes |
| | c = b*(a<0) + c*(1−(a<0)) |
| | Processors often come equipped with guarded instructions |
| | that implement this technique. |
| C) | use logic instructions to impose conditionals |
| | b*(a<0) |
| | becomes |
| | b&( a<0 ? 0xffff : 0x0000) (example fields are 16 bits and |
| | constants are in hex) |
| D) | apply logical values to the calculation of storage |
| | addresses and array subscripts. This includes the technique |
| | of piling which conditionally suppresses the advancement |
| | of an array index which is being sequentially written. For |
| | example: |
| | if (a<0) then {c[i]=b; i++} |
| | becomes |
| | c[i]=b; i += (a<0) |
| | In this case, the two pieces of code are not exactly |
| | equivalent. The array c may need an extra guard index at |
| | the end. The user knows whether or not to discard the last |
| | value in c by inspecting the final value of i. |

Add/Shift

Processors that have partitioned arithmetic often have ADD instructions that act on each field independently. Some of these processors have other kinds of field-by-field instructions (e.g., partitioned arithmetic right shift which shifts right, does not shift one field into another, and does copy the MSB of the field, the sign bit, into the just vacated MSB).

Comparisons and Field Masks

Some of these processors have field-by-field comparison instructions, generating multiple condition bits. If not, the partitioned subtract instruction is often pressed into service for this function. In this case, a<b is computed as a−b with a minus sign indicating true and a plus sign indicating false. The other bits of the field are not relevant. Such a result can be converted into a field mask of all 1's for true or all 0's for false, as used in the example in C) of Table 2, by means of a partitioned arithmetic right shift with a sufficiently long shift. This results in a multi-field comparison in two instructions.

If a partitioned arithmetic right shift is not available, a field mask can be constructed from the sign bit by means of four instructions found on all contemporary processors. These are set forth in Table 3.

TABLE 3

| | |
|---|---|
| 1. | Set the irrelevant bits to zero by u = u & 0x8000 |
| 2. | Shift to LSB of the field v = u >> 15 (logical shift |
| | right for 16 bit fields) |
| 3. | Make field mask w = (u−v) \| u |
| 4. | A partitioned zero test on a positive field x can be |
| | performed by x + 0x7fff so that the sign bit is zero if and |
| | only if x is zero. If the field is signed, one may use x \| x + |
| | 0x7fff. The sign bit can be converted to a field mask as |
| | described above. |

Of course, the condition that all fields are zero can be tested in a single instruction by comparing the total (un-partitioned) word of fields to zero.

Representations

It is useful to define some constants. A zero word except for a “1” in the MSB position of each field-partition is called MSB. A zero word except for a “1” in the LSB position of each field-partition is called LSB. The number of bits in a bit-partition is B. Unless otherwise stated, all words are unsigned (Uint) and all right shifts are logical with zero fill on the left.

A single information bit in a multi-bit field-partition can be represented in many different ways. The mask representation has all of the bits of a given field-partition equal to each other and equal to the information bit. Of course, the information bits may vary from one field-partition to another within a word.

Another useful representation is the MSB representation. The information bit is stored in the MSB position of the corresponding field-partition and the remainder of the field-partition bits are zero. Analogously, the LSB representation has the information bit in the LSB position and all others zero.

Another useful representation is the ZNZ representation where a zero information bit is represented by zeros in every bit of a field-partition and a “1” information bit otherwise. All of the mask, MSB, and LSB representations are ZNZ representations, but not necessarily vice versa.

Conversions

Conversions between representations may require one to a few word length instructions, but those instructions process all field-partitions simultaneously.

MSB→LSB

As an example, an MSB representation x can be converted to an LSB representation y by a word logical right shift instruction, y=(((Uint)x)>>B). An LSB representation x is converted to an MSB representation y by a word logical left shift instruction, y=(((Uint)x)<<B).

Mask→LSB

The mask representation m can be converted to the MSB representation by clearing the non-MSB bits. On most processors, all field-partitions of a word can be converted from mask to MSB in a single “andnot” instruction (m̂˜MSB). Likewise, the mask representation can be converted to the LSB representation by a single “andnot” instruction (m̂˜LSB).

MSB→Mask

Conversion from MSB representation x to mask representation z can be done with the following procedure using word length instructions. See Table 4.

TABLE 4

| | |
|---|---|
| 1. | Convert the MSB representation x to an LSB |
| | representation y. |
| 2. | Word subtract y from x giving v. This is the |
| | mask except for the MSB bits which are zero. |
| 3. | Word OR v with x to give the mask result z. |
| | The total procedure is z = (x − (x >> B)) [symbol] x. |

ZNZ→MSB

All of the field partitions of a word can be converted from ZNZ x to MSB y as follows. One may use the word add instruction to add to the ZNZ a word with zero bits in the MSB positions and “1” bits elsewhere. The result of this add may have the proper bit in the MSB position, but the other bit positions may have anything. This is remedied by applying an “andnot” instruction to clear the non-MSB bits. y=(x+˜msb)̂˜MSB.

Other

Other representations can be reached from the MSB representation as above.

Bit Output

In some applications (e.g., entropy codecs), one may want to form a bit string by appending given bits, one-by-one, to the end of the bit string. The current description will now indicate how to do this in a field-partition parallel way. The field partitions and associated bit strings may be independent of each other, each representing a parallel instance.

The process is to work the following way set forth in Table 5.

TABLE 5

| | |
|---|---|
| 1. | Both the input bits and a valid condition are |
| | supplied in mask representation. |
| 2. | The information bits are conditionally (i.e. |
| | conditioned on valid true) appended until a field-partition is |
| | filled. |
| 3. | When a field-partition is filled, it is appended to the |
| | end of a corresponding field-partition string. Usually, the |
| | lengths of the field-partitions are all equal and a divisor of |
| | the word-length. |

The not-yet-completely-filled independent field-partitions are held in a single word, called the accumulator. There is an associated bit-pointer word in which every field-partition of that word contains a single 1 bit (i.e. the rest zeros). That single 1 bit is in a bit position that corresponds to the bit position in the accumulator to receive the next appended bit for that field-partition. If the field-partition of the accumulator fills completely, the field-partition is appended to the corresponding field-partition string and the accumulator field-partition is reset to zero.

Information Bit Output

Appending (conditionally) the incoming information bit may be feasible. The input bit mask, the valid mask, and the bit-pointer are wordwise “ANDed” together and then wordwise “ORed” with the accumulator. This takes 3 instruction executions per word on most processors.

Bit-Pointer Update

Assuming that the bits are being appended at the LSB end of the bit string, a non-updated bit-pointer bit in the LSB of a field-partition indicates that that field-partition is filled. In any case, the bit-pointer word may updated by rotating each valid field-partition of the bit-pointer right one position. The method for doing this is as follows in Table 6.

TABLE 6

| | |
|---|---|
| a) | Separate the bit-pointer into LSB bits and non-LSB |
| | bits. (2 word AND instructions) |
| b) | Word logical shift the non-LSB bits word right one. |
| | (1 word SHIFT instruction) |
| c) | Word logical shift the non-LSB bits word left to the |
| | MSB positions (1 word SHIFT instruction) |
| d) | Word OR the results of b) and c) together (1 word |
| | OR instruction) |
| e) | Mux together bitwise the results of d) and the |
| | original bit-pointer. Use the valid mask to control the mux |
| | (1 XOR, 2 AND, and 1 OR word instructions on most |
| | processors) |

Accumulator is Full

As stated above, a field-partition is full if the corresponding field-partition of the bit-pointer p has its 1 in the LSB partition. Any field-partition of the accumulator full is indicated by the word of LSB bits only of the bit-pointer p not zero. f=(p̂LSB); full=(f≠0)

The probability of full is usually significantly less than 0.5 so that an application of piling is in order. Both the accumulator a and f are piled to pile A1, using full as the condition. The length of pile A1 may be significantly less than the number of bit append operations. Piling is designed so that processing does not necessarily involve control flow changes other than those involved in the overall processing loop.

At a later time, pile A1 is processed by looping through the items in A1. For each item in A1 the field-partitions are scanned in sequence. The number of field-partitions per word is small, so this sequence can be performed by straight-line code with no control changes.

One may expect that, on the average, only one field-partition in a word may be full. Therefore, another application of piling (to pile A2) is in order. Each of the field-partitions of a, a2, along with the corresponding field partition index i, are piled to A2 using the corresponding field-partition off as the pile write condition. In the end, A2 may contain only those field-partitions that are full.

At a later time, pile A2 is processed by looping through the items of A2. The index I is used to select the bit-string array to which the corresponding a2 should be appended. The file-partition size in bits, B, is usually chosen to be a convenient power of two (e.g., 8 or 16 bits). Store instructions for 8 bit or 16 bit values make those lengths convenient. Control changes other than the basic loops are not necessarily required throughout the above processes.

Bit Field Scanning

A common operation required for codecs is the serial readout of bits in a field of a word. The bit to be extracted from a field x is designated by a bit_pointer, a field value of 0s except for a single “1” bit (e.g., 0x0200). The “1” bit is aligned with the bit to be extracted so that x & bit_pointer is zero or non-zero according to the value of the read out bit. This can be converted to a field mask as described above. Each instruction in this sequence may simultaneously process all of the fields in a word.

The serial scanning is accomplished by shifting the bit_pointer in the proper direction and repeating until the proper terminating condition. Since not all fields may terminate at the same bit position, the above procedure may be modified so that terminated fields do not produce an output while unterminated fields do produce an output. This is accomplished by producing a valid field mask that is all “1”s if the field is unterminated or all “0”s if the field is terminated. This valid field mask is used as an output conditional. The actual scanning is continued until all fields are terminated, indicated by valid being a word of all zeros.

The terminal condition is often the bit in the bit_pointer reaching a position indicated by a “1” bit in a field of terminal_bit_pointer. This may be indicated by a “1” bit in bit_pointer & terminal_bit_pointer. These fields may be converted to the valid field mask as described above.

While it may appear that the present description has many sequential dependencies and a control flow change for each bit position scanned, this loop can be unrolled to minimize the actual compute time required. In the usual application of bit field scanning, the fields all have the same number of bits leading to a loop termination condition common to all of the fields.

Congruent Sub-Fields of Field-Partitions

If one wishes to append bit positions c:d of each field-partition of word w onto the corresponding bit-strings, one may let the constant c be a zero word except for a “1” in bit position c of each field-partition. Likewise, one may let the constant d be a zero word except for a “1” in bit position d of each field-partition. Moreover, the following operations may be performed. See Table 7.

TABLE 7

| | |
|---|---|
| A) | initialize the bit-pointer q to c q = c; |
| | A1) initialize COND to all true |
| B) | wordwise bitand q with w u = q [symbol] w |
| | u is in ZNZ representation |
| C) | convert u from ZNZ representation to mask |
| | representation v |
| D) | v can now be bit-string output as described |
| | above. |
| | Use a COND of all true. |
| E) | if cond = (q == d) processing is done; |
| | otherwise wordwise logical |
| | shift q right one (q >> 1) loop back to step B) |

The average value of (d−c) is often quite small for entropy codec applications. The test in operation E) can be initiated as early as operation B) with the branch delayed to operation E) and operations B)-D) available to cover the branch pipeline delay. Also, since the sub-fields are congruent it is relatively easy to unroll the processing of several words to cover the sequential dependencies within the instructions for a single word of field-partitions.

Non-Congruent Sub-Fields of Field-Partitions

In the case that c and d vary by field-partition, c and d remain as above but the test in operation E) above varies by field-partition rather than being the same for all field-partitions of the word. In this case, one may want the scan-out for the completed field partitions to idle until all field-partitions have completed. One may need to modify the above procedure in the following ways in Table 8.

TABLE 8

| | |
|---|---|
| 1) | Step D) may need a condition where the field- |
| | partition value is false for completed field-partitions and |
| | true for not-yet-completed field-partitions. This is |
| | accomplished by appending to operation E) an operation |
| | which “andnot” the cond word onto COND. COND = |
| | (COND [symbol] ~cond) |
| 2) | The if condition in step E) needs to be modified to |
| | loop back to B) unless COND is all FALSE. |
| | Thus, the operations become: |
| A) | initialize the bit-pointer q to c q = c; |
| A1) | initialize COND to all true |
| B) | wordwise bitand q with w u = q [symbol] w |
| | u is in ZNZ representation |
| C) | convert u from ZNZ representation to mask |
| | representation v |
| D) | v can now be bit-string output as described above. |
| | Use a COND of all true. |
| E1) | cond = (q == d); COND = (COND [symbol] ~cond); |
| E2) | if COND==0 processing is done; otherwise |
| | wordwise logical shift q |
| | right one (q >> 1) loop back to operation B) |

Binary to Unary—Bit Field Countdown

A common operation in entropy coding is that of converting a field from binary to unary—that is producing a string of n ones followed by a zero for a field whose value is n. In most applications, the values of n are expected to have a negative exponential distribution with a mean of one so that, on the average, one may expect to have just one “1” in addition to the terminal zero in the output.

A field-partition parallel method for positive fields with leading zeros is as follows. As above, let c be a constant all zeros except for a “1” in the MSB position of each field of the word X. Let d be a constant all zeros except for a “1” in the LSB position of each field. Let diff=c−d. Initialize mask to diff.

The procedure is to count down (in parallel) the fields in question and at the same time carry up into the initially zero MSB position c. If the MSB position is a “1” after the subtraction, the previous value of the field was not zero and a “1” should be output. If the MSB position is a zero after the subtraction, the previous value of the field was zero and a zero should be output. In any case, the MSB position contains the bit to be output for the corresponding field-partition of the word X.

Once the field has reached zero and the first zero is output, further outputs of zero may be suppressed. Since different field-partitions of X may have different values and output different numbers of bits, output from the field-partitions having smaller values may be suppressed until all field values have reached zero. This suppression is implemented by means of the mask input to the bit output procedure, as described earlier. Once the first zero for a field-partition has been output, the corresponding field-partition of the mask is turned zero, suppressing further output.

In the usual case where diff is the same for each field-partition, it is not necessary to change diff to zero. Otherwise, diff may be ANDed with the mask. See Table 9.

TABLE 9

While mask ≠ 0
X = X + diff
Y = ZNZ_2_mask(c [symbol] X) where ZNZ_2_mask is the ZNZ
to mask conversion above
X = X [symbol] ~c
Output Y with mask as described above
mask = mask [symbol] Y
In the case of typical pipeline latencies for jumps, it may
make sense to unroll the above loop according to the
estimated probability distribution of the number of its turns.

Optimizing Loop Unrolling for Partitioned Computations

If one has a loop of the form: while c, {s}, the probability of c==true on the ith iteration is Pᵢ, the cost of computing c and looping back is C(c), and the cost of computing s is C(s). One may assume that extra executions of s do not affect the output of the computation but do each incur the cost C(s).

One may unroll the loop n times so that the computation becomes s; s; s; . . . s; while c, {s} where there are n executions of s preceding the while loop. The total cost is then that set forth in Table 10.

TABLE 10

$nC ( s ) + ( C ( c ) + {P}_{n} ( C ( s ) + C ( c ) + {P}_{n + 1} ( ⃛ ) ) ) = \\ nC ( s ) + C ( c ) + ( {P}_{n} + {P}_{n} {P}_{n + 1} + ⃛ ) ( C ( c ) + C ( s ) ) \approx \approx \\ ( n - 1 ) α + {U}_{n} = TC ( n , α ) \\ where {U}_{n} = ( {P}_{n} + {P}_{n} {P}_{n + 1} + ⃛ ) and α = \frac{C ( s )}{C ( c ) + C ( s )}$

As an example, one may suppose that he or she has k independent fields per word and that p is the probability of looping back for each individual field. Then, Pₙ=1−(1−pⁿ)^{k}.

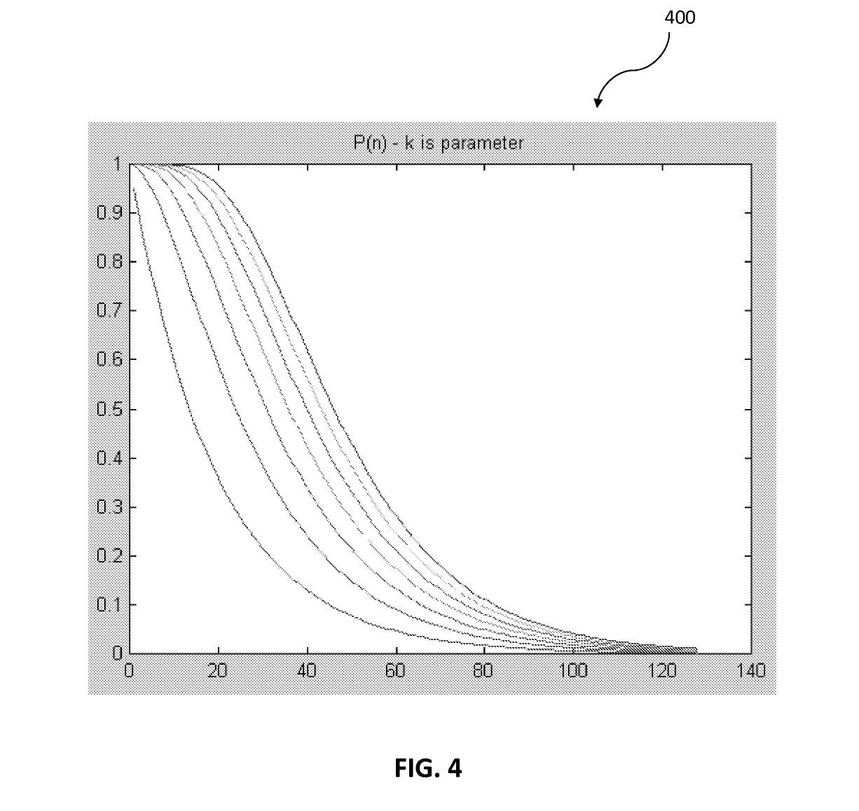

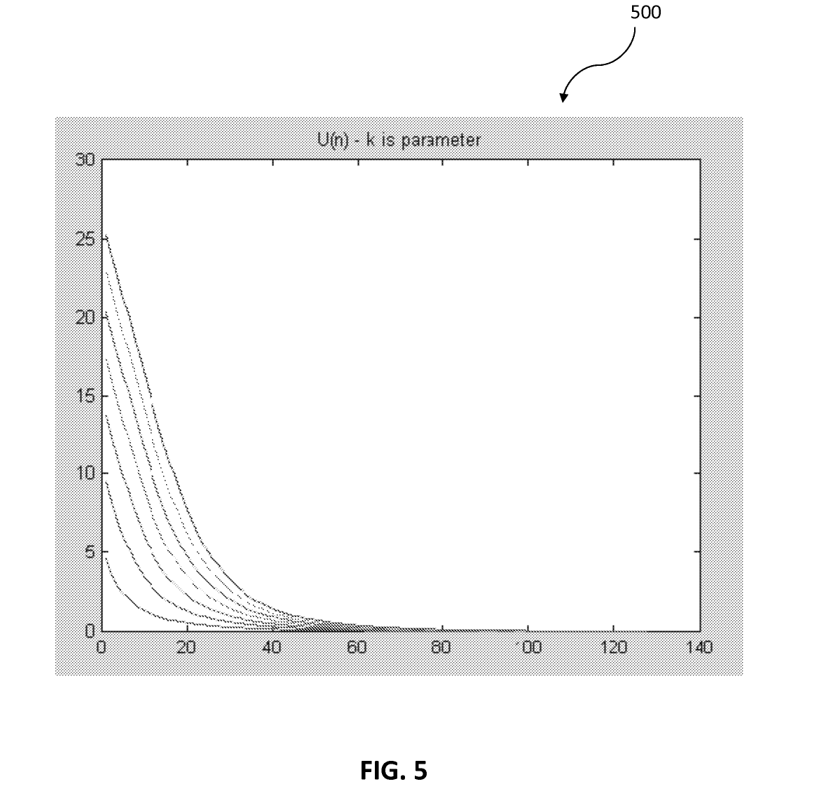

FIG. 4 shows a graph 400 illustrating Pₙ, in accordance with one embodiment. FIG. 5 shows a graph 500 illustrating the corresponding Uₙ, in accordance with one embodiment. The curves in each figure correspond to the values of k with blue corresponding to k=1).

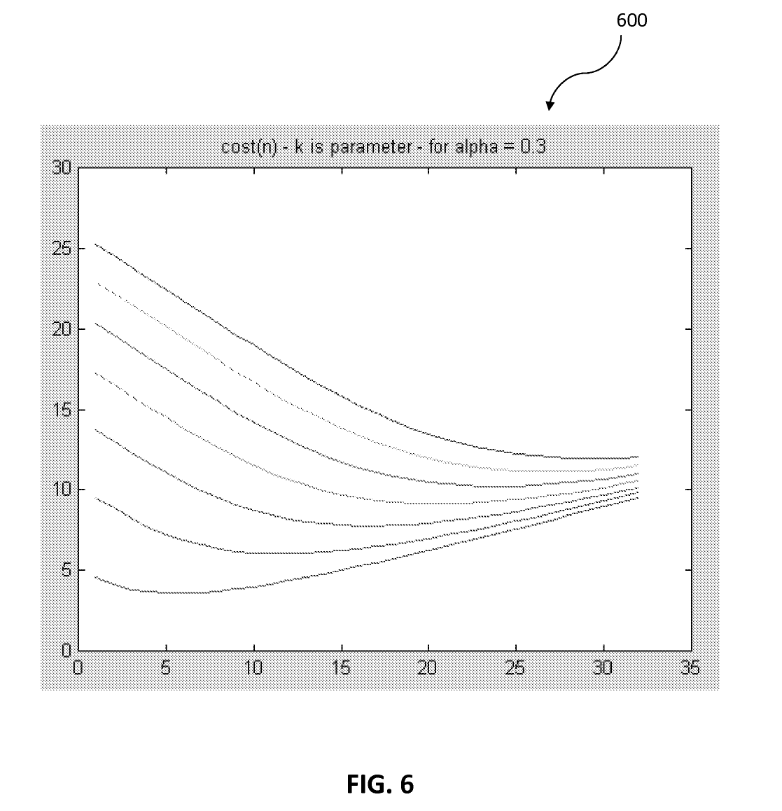

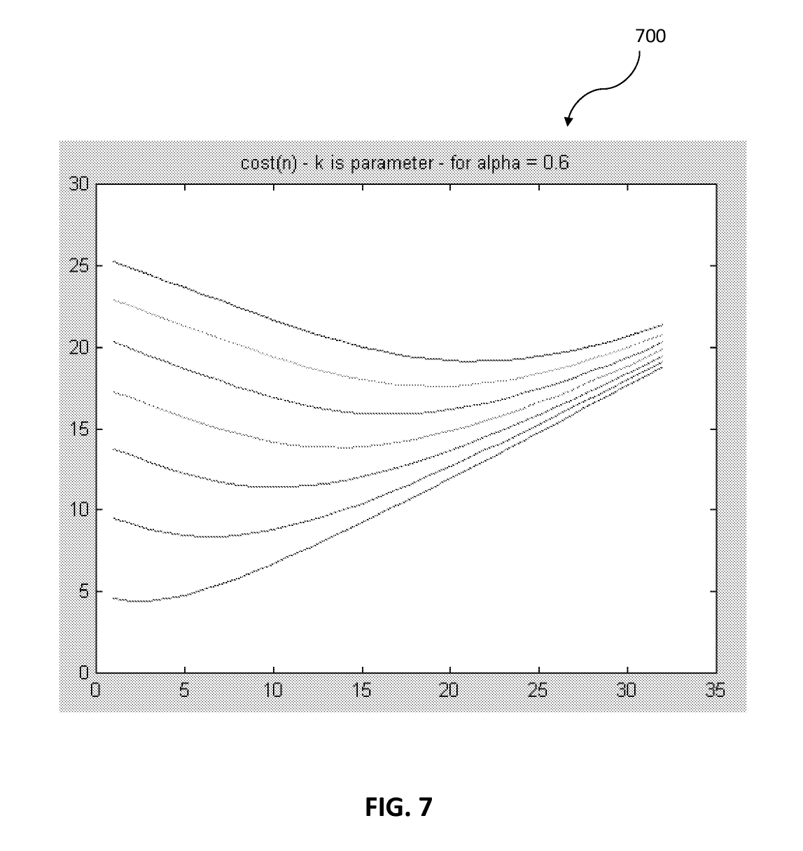

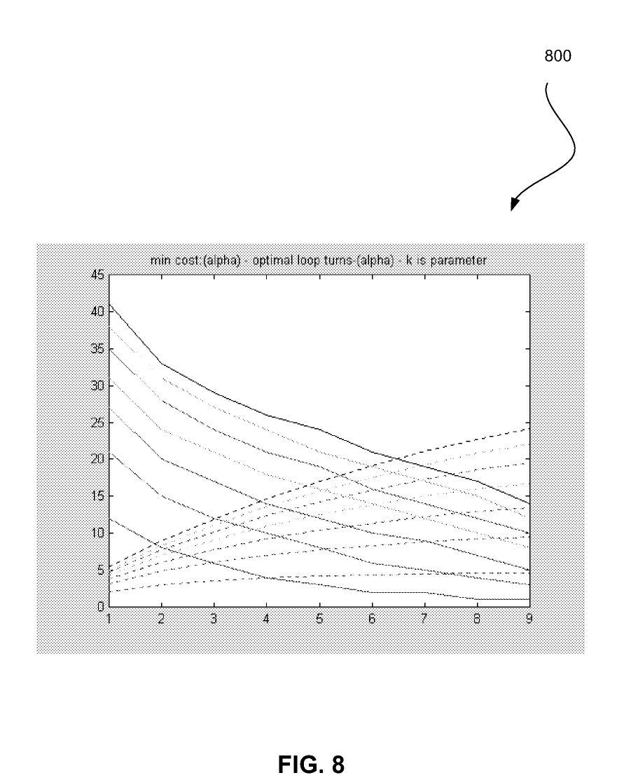

FIGS. 6 and 7 illustrate graphs 600 and 700 indicating the normalized total cost TC(n,α) for α=0.3 and α=0.7, respectively. FIG. 8 is a graph 800 illustrating the minimal total cost

$${min}_{n} ( TC ( n , α ) ) = \overline{TC} ( α )$$

(dotted lines) and the optimal number of initial loop unrolls n̅(α), in accordance with one embodiment.

### Example

In entropy coding applications, output bits may have a 0.5 probability of being one and a 0.5 probability of being zero. They may also be independent. With these assumptions, one can make the following calculations.

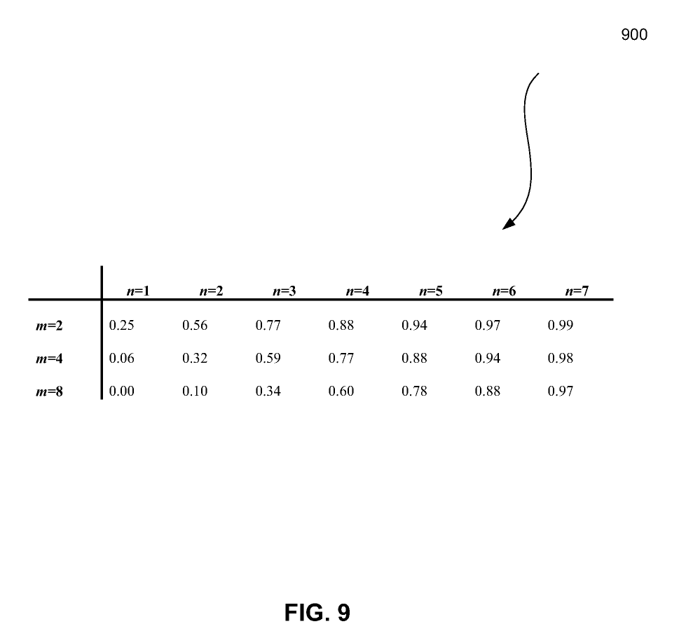

The probability P(n) that a given field-partition may require n or less output bits (including the terminating zero) is P(n)=(1−0.5⁻ⁿ). Let the number of field-partitions per word be m. Then the probability that the required number of turns around the loop is n or less is (P(n))^{m}=(1−0.5⁻ⁿ)^{m}. FIG. 9 illustrates a table 900 including various values of the foregoing equation, in accordance with one embodiment. As shown, unrolling of the loop above 2-4 times seems to be in order.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method of compressing data, comprising:
transforming data;
quantizing the data; and
encoding the data;
wherein:
at least one of the transforming, quantizing, or encoding comprises:
processing computational operations in a loop;
identifying exceptions while processing the computational operations;
storing the exceptions while processing the computational operations; and
processing the exceptions separate from the loop.
